(19) United States
(12) Patent Application Publication
(10) Pub. No.: US 2025/0108565 A1
(43) Pub. Date: Apr. 3, 2025

(54) THREE-DIMENSIONAL MOLDING SYSTEM

(71) Applicant: SEIKO EPSON CORPORATION, Tokyo (JP)

(72) Inventor: Shigeru YAMAZAKI, SHIOJIRI-SHI (JP)

(21) Appl. No.: 18/898,977

(22) Filed: Sep. 27, 2024

(30) Foreign Application Priority Data
Sep. 29, 2023 (JP) 2023-169229

(51) Int. Cl. B29C 64/393; B29C 64/25; B33Y 30/00; B33Y 50/02

(52) U.S. Cl. CPC B29C 64/393; B29C 64/25; B33Y 30/00; B33Y 50/02

(57) ABSTRACT

A three-dimensional molding system includes a molding unit including a heater for plasticizing a material to generate a molding material and a nozzle for discharging the molding material, a stage, a position changing unit configured to change relative positions of the stage and the nozzle, an imaging unit disposed further on an outer side than an outer edge of the molding surface when viewed from a direction perpendicular to the molding surface, a housing including an inner wall that defines an internal space and an outer wall, and a control unit configured to control the molding unit and the position changing unit based on molding data. At least a part of the inner wall is made of a first transparent member, and the imaging unit is disposed between the inner wall and the outer wall.

The present application is based on, and claims priority from JP Application Serial Number 2023-169229, filed Sep. 29, 2023, the disclosure of which is hereby incorporated by reference herein in its entirety.

### BACKGROUND

### 1. Technical Field

The present disclosure relates to a three-dimensional molding system.

### 2. Related Art

JP-T-2015-507250 discloses a three-dimensional molding apparatus including a video camera. The three-dimensional molding apparatus captures a video of a modeled object being modeled with the video camera and transmits the video to a distant place.

JP-T-2015-507250 is an example of the related art.

By disposing an imaging unit near a molding region where a three-dimensional molded object is molded, the molded object can be finely imaged. However, when the imaging unit is disposed near the molding region, the imaging unit is likely to be affected by heat involved in the molding.

### SUMMARY

According to a first aspect of the present disclosure, a three-dimensional molding system is provided. The three-dimensional molding system includes: a molding unit including a heater for plasticizing a material to generate a molding material and a nozzle for discharging the molding material; a stage including a molding surface on which the molding material is stacked; a position changing unit configured to change relative positions of the stage and the nozzle; an imaging unit disposed further on an outer side than an outer edge of the molding surface when viewed from a direction perpendicular to the molding surface; a housing including an inner wall that defines an internal space and an outer wall that comes into contact with outside air and configured to house the molding surface in the internal space; and a control unit configured to control the molding unit and the position changing unit based on molding data to mold a three-dimensional molded object on the molding surface in the housing, wherein at least a part of the inner wall is made of a first transparent member, and the imaging unit is disposed between the inner wall and the outer wall and images, via the first transparent member, the three-dimensional molded object on the molding surface housed in the internal space.

### BRIEF DESCRIPTION OF THE DRAWINGS

FIG. 1 is a diagram illustrating a schematic configuration of a three-dimensional molding system.

FIG. 2 is a diagram illustrating disposition of an imaging unit.

FIG. 3 is a perspective view illustrating a schematic configuration of a flat screw.

FIG. 4 is a schematic plan view of a barrel.

FIG. 5 is a diagram of molding processing executed in a control unit.

FIG. 6 is a diagram illustrating a schematic configuration of an information processing apparatus.

FIG. 7 is a diagram illustrating an example of attribute information.

FIG. 8 is a flowchart of imaging processing.

FIG. 9 is a diagram of the imaging processing.

FIG. 10 is a diagram illustrating another processing example of the imaging processing.

FIG. 11 is a flowchart of imaging processing in a second embodiment.

FIG. 12 is a diagram of the imaging processing in the second embodiment.

FIG. 13 is a flowchart of molding data correction processing in a third embodiment.

FIG. 14 is a diagram illustrating a first example of the molding data correction processing.

FIG. 15 is a diagram illustrating a second example of the molding data correction processing.

FIG. 16 is a diagram illustrating a third example of the molding data correction processing.

FIG. 17 is a flowchart of stereoscopic image generation processing in a fourth embodiment.

FIG. 18 is a diagram of the stereoscopic image generation processing.

FIG. 19 is a diagram illustrating a first modification of the fourth embodiment.

FIG. 20 is a diagram illustrating a second modification of the fourth embodiment.

### DESCRIPTION OF EMBODIMENTS

### A. First Embodiment

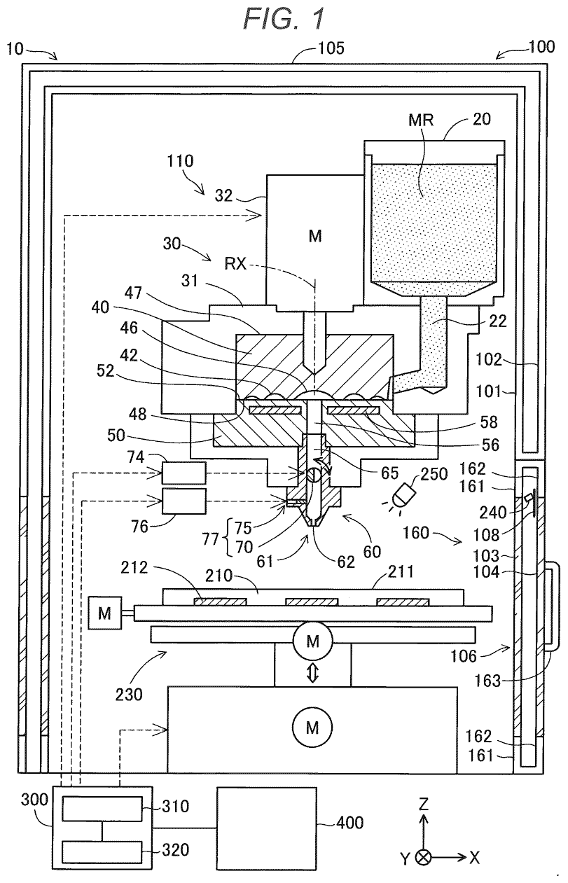

FIG. 1 is a diagram illustrating a schematic configuration of a three-dimensional molding system 10 in a first embodiment. In FIG. 1, arrows indicating X, Y, and Z directions orthogonal to one another are illustrated. The X direction and the Y direction are directions parallel to the horizontal plane. The Z direction is a direction along a vertically upward direction. The arrows indicating the X, Y, and Z directions are illustrated as appropriate in other drawings as well such that illustrated directions correspond to those in FIG. 1. In the following explanation, when a direction is specified, a direction indicated by an arrow in the figures is represented as “+” and a direction opposite to the direction is represented as “−”, and the positive and negative signs are also used in direction notation. Hereinafter, a +Z direction is also referred to as “upper” and a −Z direction is also referred to as “lower”.

The three-dimensional molding system 10 includes a three-dimensional molding apparatus 100 and an information processing apparatus 400 that communicates with the three-dimensional molding apparatus 100. The information processing apparatus 400 and the three-dimensional molding apparatus 100 can communicate with each other via a predetermined communication line such as the Internet or a LAN.

The three-dimensional molding apparatus 100 of the present embodiment is an apparatus that shapes a three-dimensional molded object by a material extrusion method. The three-dimensional molding apparatus 100 includes a control unit 300 for controlling units of the three-dimensional molding apparatus 100. The control unit 300 and the information processing apparatus 400 are communicably coupled to each other. Hereinafter, a three-dimensional molded object is also referred to as a model.

The three-dimensional molding apparatus 100 includes a housing 105, a molding unit 110 that generates a molding material and discharges the molding material from a nozzle 61, a stage 210 having a molding surface 211 on which the molding material is stacked, a position changing unit 230 that changes relative positions of the stage 210 and the nozzle 61, an imaging unit 240, and a light 250. The molding surface 211 of the stage 210 is housed in the housing 105.

A door 160 is provided in the housing 105. A handle 163 is provided in the door 160. By holding the handle 163 and opening the door 160, a user can take out a model molded in the housing 105.

The housing 105 includes an inner wall 101 that defines an internal space and an outer wall 102 that comes into contact with the outside air. The housing 105 houses the molding surface 211 in the internal space. At least a part of the inner wall 101 is configured by a first transparent member 103. The first transparent member 103 is, for example, glass. When viewed from the +Z direction that is a direction perpendicular to the molding surface 211, the imaging unit 240 is disposed further on the outer side than the outer edge of the molding surface 211 in the X direction and the Y direction. The imaging unit 240 is disposed between the inner wall 101 and the outer wall 102. The imaging unit 240 images, via the first transparent member 103, a model on the molding surface 211 housed in the internal space. The imaging unit 240 is coupled to the control unit 300. The imaging of the model by the imaging unit 240 is controlled by the control unit 300. The imaging unit 240 is configured by, for example, a CCD camera or a CMOS camera. In another embodiment, the imaging unit 240 may be configured by, for example, a laser scanner or a LiDAR. The imaging unit 240 includes an actuator capable of adjusting an imaging range by the imaging unit 240. The control unit 300 is capable of imaging any position on the molding surface 211 by controlling the imaging unit 240.

The door 160 includes a part of the inner wall 101 and a part of the outer wall 102. That is, the door 160 configures a part of the housing 105. A part of the inner wall 101 configuring the door 160 is configured by the first transparent member 103. A part of the outer wall 102 configuring the door 160 is configured by a second transparent member 104 facing the first transparent member 103. Like the first transparent member 103, the second transparent member 104 is, for example, glass. The first transparent member 103 and the second transparent member 104 facing the first transparent member 103 configure a window 106. The door 160 includes a first frame 161 surrounding the first transparent member 103 and a second frame 162 surrounding the second transparent member 104. That is, the door 160 includes the first frame 161 and the second frame 162 surrounding the window 106. The first frame 161 is a part of the inner wall 101 and the second frame 162 is a part of the outer wall 102. At least a part of the imaging unit 240 is disposed in an upper space in a space between the first frame 161 and the second frame 162. At least a part of the imaging unit 240 is, for example, a portion of the imaging unit 240 excluding a lens provided in the imaging unit 240. A cover 108 that covers the imaging unit 240 from the outer wall 102 side is disposed between the inner wall 101 and the outer wall 102 configuring the door 160. At least a part of the rear surface of the cover 108 faces the second transparent member 104.

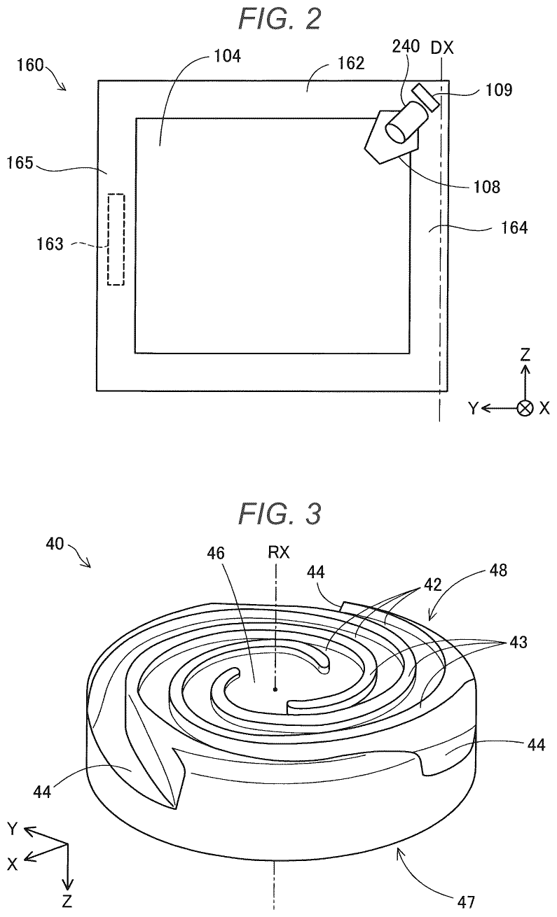

FIG. 2 is a diagram illustrating disposition of the imaging unit 240. FIG. 2 illustrates a state in which the door 160 is viewed in the +X direction from the internal space of the housing 105 in a state in which the door 160 is closed. In FIG. 2, the first transparent member 103 and the first frame 161 are omitted.) At least a part of the imaging unit 240 is disposed in a space at an upper corner in the space between the first frame 161 and the second frame 162.

The door 160 includes a first end portion 164 and a second end portion 165. In the present embodiment, in a state in which the door 160 is closed, the first end portion 164 is located on the −Y direction side and the second end portion 165 is located on the +Y direction side opposite to the first end portion 164. The first end portion 164 has an opening and closing axis DX that is a rotation axis for opening and closing the door 160. The distance from the imaging unit 240 to the first end portion 164 is shorter than the distance from the imaging unit 240 to the second end portion 165. In the present embodiment, the imaging unit 240 is located near the opening and closing axis DX of the door 160. A cooling unit 109 for cooling the imaging unit 240 is provided in the vicinity of the imaging unit 240. The cooling unit 109 in the present embodiment is an air cooling fan. The cooling unit 109 may be configured by a cooling device such as a chiller including a coolant flow path disposed around the imaging unit 240 and a pump that flows a coolant through the coolant flow path. The cooling unit 109 can also be omitted.

The light 250 illustrated in FIG. 1 illuminates the internal space of the housing 105. The light 250 includes an actuator capable of adjusting an illumination range. The control unit 300 is capable of illuminating any range on the molding surface 211 by controlling the light 250. In the present embodiment, the light 250 can also be omitted.

The molding unit 110 discharges, under control of the control unit 300, a molding material obtained by plasticizing a material in a solid state onto the stage 210. The molding unit 110 includes a material supply unit 20 that is a supply source of a raw material before being converted into a molding material, a plasticizing unit 30 that converts the raw material into the molding material, and a discharge unit 60 that discharges the molding material.

The material supply unit 20 supplies a raw material MR to the plasticizing unit 30. The material supply unit 20 is configured by, for example, a hopper that stores the raw material MR. The material supply unit 20 is coupled to the plasticizing unit 30 via a communication path 22. The raw material MR is put in the material supply unit 20 in a form of pellets, powder, or the like. As the raw material, a resin material such as acrylonitrile butadiene styrene (ABS), polyetheretherketone (PEEK), or polypropylene (PP) is used.

The plasticizing unit 30 plasticizes the raw material MR supplied from the material supply unit 20 to generate a paste-like molding material exhibiting fluidity and guides the molding material to the discharge unit 60. In the embodiment, the term “plasticize” is a concept including melting and means changing a solid state to a state having fluidity. Specifically, in the case of a material in which glass transition occurs, the term “plasticize” means setting the temperature of the material to temperature equal to or higher than the glass transition point. In the case of a material in which glass transition does not occur, plasticizing means setting the temperature of the material to be equal to or higher than the melting point.

The plasticizing unit 30 includes a screw case 31, a driving motor 32, a flat screw 40, and a barrel 50. The flat screw 40 is also called rotor or scroll. The barrel 50 is also called screw facing section.

The flat screw 40 is housed in the screw case 31. An upper surface 47 of the flat screw 40 is coupled to the driving motor 32. The flat screw 40 is rotated in the screw case 31 by a rotational driving force generated by the driving motor 32. The driving motor 32 is driven under the control of the control unit 300. The flat screw 40 may be driven by the driving motor 32 via a decelerator. FIG. 3 is a perspective view illustrating a schematic configuration of a lower surface 48 side of the flat screw 40. In order to facilitate understanding of the technique, the flat screw 40 illustrated in FIG. 3 is illustrated in a state in which a positional relationship between the upper surface 47 and the lower surface 48 illustrated in FIG. 1 is reversed in the vertical direction. The flat screw 40 has a substantially cylindrical shape in which length in the axial direction, which is a direction along the center axis of the flat screw 40, is smaller than length in a direction perpendicular to the axial direction. The flat screw 40 is disposed such that a rotation axis RX serving as a rotation center of the flat screw 40 is parallel to the Z direction.

Grooves 42 having a swirl shape are formed on the lower surface 48 of the flat screw 40 that is a surface intersecting the rotation axis RX. The communication path 22 of the material supply unit 20 explained above communicates with the grooves 42 from a side surface of the flat screw 40. In the present embodiment, three grooves 42 are formed by being separated by ridges 43. The number of grooves 42 is not limited to three and may be one or may be two or more. The grooves 42 are not limited to the swirl shape and may have a spiral shape or an involute curve shape or may have a shape extending to draw an arc from the center toward the outer periphery.

As illustrated in FIG. 1, the lower surface 48 of the flat screw 40 faces an upper surface 52 of the barrel 50. A space is formed between the grooves 42 of the lower surface 48 of the flat screw 40 and the upper surface 52 of the barrel 50. The raw material MR is supplied from the material supply unit 20 to the space between the flat screw 40 and the barrel 50 through material inlets 44 illustrated in FIG. 3.

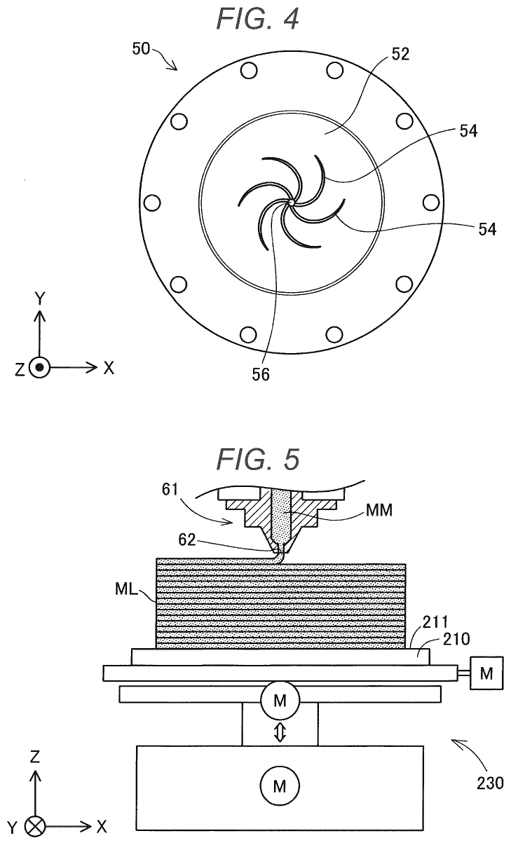

FIG. 4 is a schematic plan view illustrating the upper surface 52 side of the barrel 50. A communication hole 56 is provided at a center of the barrel 50. A plurality of guide grooves 54 coupled to the communication hole 56 and extending in a swirl shape from the communication hole 56 toward the outer periphery are formed on the upper surface 52 of the barrel 50. One ends of the guide grooves 54 may not be coupled to the communication hole 56. The guide grooves 54 may be omitted. As illustrated in FIG. 1, a barrel heater 58 for plasticizing the raw material MR supplied into the grooves 42 of the rotating flat screw 40 to generate a molding material is embedded in the barrel 50.

The raw material MR supplied into the grooves 42 of the flat screw 40 flows along the grooves 42 by the rotation of the flat screw 40 while being plasticized in the grooves 42 and is guided to a center 46 of the flat screw 40 as a molding material. The paste-like molding material exhibiting fluidity, which has flowed into the center 46, is supplied to the discharge unit 60 via the communication hole 56 provided at the center of the barrel 50. In the molding material, not all kinds of substances forming the molding material may be plasticized. The molding material only has to be converted into a state having flowability as a whole by at least a part of the substances forming the molding material being plasticized.

The discharge unit 60 illustrated in FIG. 1 includes the nozzle 61 that discharges the molding material, a flow path 65 for the molding material provided between the flat screw 40 and a nozzle opening 62, and a discharge control unit 77 that controls the discharge of the molding material.

The nozzle 61 is coupled to the communication hole 56 of the barrel 50 through the flow path 65. The nozzle 61 discharges the molding material, which was generated in the plasticizing unit 30, from the nozzle opening 62 at the distal end of the nozzle 61 toward the stage 210.

The discharge control unit 77 includes a discharge adjustment unit 70 that opens and closes the flow path 65 and a suction unit 75 that sucks and temporarily stores the molding material.

The discharge adjustment unit 70 is provided in the flow path 65 and changes an opening degree of the flow path 65 by rotating in the flow path 65. In the present embodiment, the discharge adjustment unit 70 is implemented by a butterfly valve. The discharge adjustment unit 70 is driven by a first driving unit 74 under the control of the control unit 300. The first driving unit 74 is configured by, for example, a stepping motor. The control unit 300 can adjust a flow rate of the molding material flowing from the plasticizing unit 30 to the nozzle 61, that is, a discharge amount of the molding material discharged from the nozzle 61 by controlling a rotation angle of the butterfly valve using the first driving unit 74. The discharge adjustment unit 70 is capable of adjusting the discharge amount of the molding material and is capable of controlling ON and OFF of an outflow of the molding material.

The suction unit 75 is coupled between the discharge adjustment unit 70 and the nozzle opening 62 in the flow path 65. When the discharge of the molding material from the nozzle 61 is stopped, the suction unit 75 temporarily sucks the molding material in the flow path 65 to thereby prevent a tailing phenomenon in which the molding material drips down from the nozzle opening 62 like a string. In the present embodiment, the suction unit 75 is configured by a plunger. The suction unit 75 is driven by a second driving unit 76 under the control of the control unit 300. The second driving unit 76 is configured by, for example, a stepping motor and a rack-and-pinion mechanism that converts a rotational force of the stepping motor into a translational motion of the plunger.

The stage 210 is disposed at a position facing the nozzle opening 62 of the nozzle 61. In the first embodiment, the molding surface 211 of the stage 210 facing the nozzle opening 62 of the nozzle 61 is disposed to be parallel to the X and Y directions, that is, the horizontal direction. The stage 210 includes a stage heater 212 for preventing the molding material discharged onto the stage 210 from being suddenly cooled. The stage heater 212 is controlled by the control unit 300.

The position changing unit 230 changes relative positions of the stage 210 and the nozzle 61 under the control of the control unit 300. In the present embodiment, the position of the nozzle 61 is fixed. The position changing unit 230 moves the stage 210. The position changing unit 230 is configured by a three-axis positioner that moves the stage 210 in three axial directions of X, Y, and Z directions with driving forces of three motors. In the present specification, unless noted otherwise, a movement of the nozzle 61 means moving the nozzle 61 or the discharge unit 60 relatively to the stage 210.

In another embodiment, a configuration in which the position changing unit 230 moves the nozzle 61 relatively to the stage 210 in a state in which the position of the stage 210 is fixed may be adopted instead of a configuration in which the stage 210 is moved by the position changing unit 230. A configuration in which the position changing unit 230 moves the stage 210 in the Z direction and moves the nozzle 61 in the X and Y directions or a configuration in which the position changing unit 230 moves the stage 210 in the X and Y directions and moves the nozzle 61 in the Z direction may be adopted. With these configurations as well, a relative positional relationship between the nozzle 61 and the stage 210 can also be changed.

The control unit 300 is a device that controls an operation of the entire three-dimensional molding apparatus 100. The control unit 300 is implemented with a computer including one or a plurality of processors 310, a storage unit 320 including a main storage unit and an auxiliary storage unit, and an input and output interface that receives and outputs signals from and to the outside. By executing a computer program stored in the storage unit 320, the processor 310 controls the molding unit 110 and the position changing unit 230 according to molding data stored in the storage unit 320 to execute molding processing of molding a model on the stage 210. The control unit 300 may be configured by a configuration obtained by combing circuits instead of being configured by the computer.

FIG. 5 is a diagram of the molding processing executed in the control unit 300. As explained above, the raw material MR in a solid state is plasticized to generate a molding material MM in the three-dimensional molding apparatus 100. The control unit 300 causes the nozzle 61 to discharge the molding material MM while changing the position of the nozzle 61 relative to the stage 210 in a direction along the molding surface 211 of the stage 210 with the distance between the molding surface 211 of the stage 210 and the nozzle 61 kept. The molding material MM discharged from the nozzle 61 is continuously deposited in the moving direction of the nozzle 61.

The control unit 300 forms layers ML by repeating the movement of the nozzle 61. After forming one layer ML, the control unit 300 relatively moves the position of the nozzle 61 with respect to the stage 210 in the Z direction. The control unit 300 further stacks the layer ML on the layer ML formed so far to thereby mold a model.

For example, the control unit 300 sometimes temporarily suspends, for example, the movement of the nozzle 61 in the Z direction in the case in which the layer ML for one layer is completed or discharge of the molding material from the nozzle 61 in the case in which a plurality of independent molding regions are present in layers. In this case, the control unit 300 causes the discharge adjustment unit 70 to close the flow path 65 to stop the discharge of the molding material MM from the nozzle opening 62 and temporarily sucks, with the suction unit 75, the molding material in the nozzle 61. After changing the position of the nozzle 61, the control unit 300 opens the flow path 65 with the discharge adjustment unit 70 while discharging the molding material in the suction unit 75 to thereby resume the deposit of the molding material MM from a changed position of the nozzle 61.

FIG. 5 illustrates an example in which one model is molded on the molding surface 211. However, the control unit 300 can simultaneously mold a plurality of models on the molding surface 211 by stacking the layers ML on different positions of the molding surface 211.

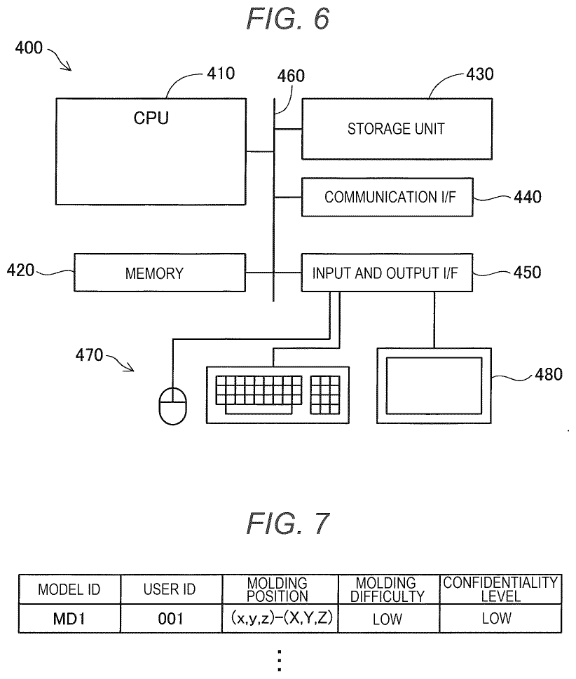

FIG. 6 is a diagram illustrating a schematic configuration of the information processing apparatus 400. The information processing apparatus 400 is configured as a computer in which a CPU 410, a memory 420, a storage device 430, a communication interface 440, and an input and output interface 450 are coupled to one another by a bus 460. An input device 470 such as a keyboard, a mouse, or a touch panel and a display unit 480 such as a liquid crystal display are coupled to the input and output interface 450. The input device 470 and the display unit 480 may be integrally provided in the information processing apparatus 400. The information processing apparatus 400 is implemented by, for example, a personal computer, a tablet terminal, or a smartphone.

The information processing apparatus 400 is coupled to the control unit 300 of the three-dimensional molding apparatus 100 via the communication interface 440. The information processing apparatus 400 transmits molding data for molding a model and model attribute information to the control unit 300. The molding data includes, for each movement path for each layer obtained by slicing the shape of the model into a plurality of pieces, path information representing a movement path of the nozzle 61 and discharge amount information representing a discharge amount of the molding material. The molding data is generated by slicer software executed by the CPU 410.

FIG. 7 is a diagram illustrating an example of the model attribute information. Each model is associated with, as attribute information, a model ID, a user ID of a user who is about to mold the model, a molding position of the model on the molding surface 211, molding difficulty of the model, and a confidentiality level representing a degree of confidentiality of the model. The confidentiality level is set by the user for each model. The molding difficulty is set by the CPU 410. Details of the molding difficulty is explained below.

Image data of a model captured by the imaging unit 240 is transmitted from the control unit 300 of the three-dimensional molding apparatus 100 to the information processing apparatus 400. When receiving the image data from the control unit 300, the CPU 410 of the information processing apparatus 400 displays an image represented by the image data on the display unit 480.

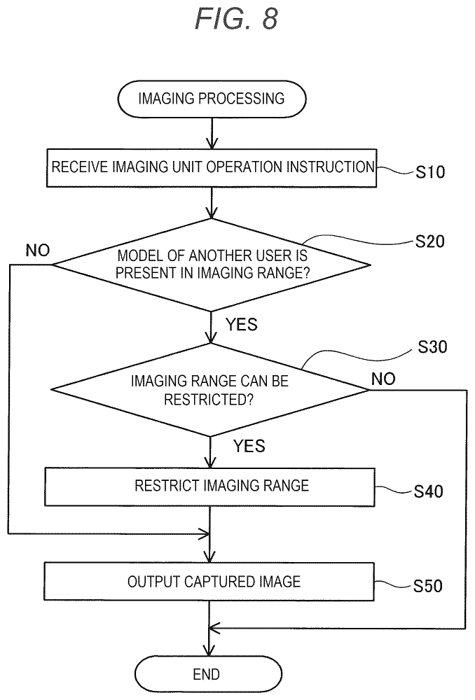

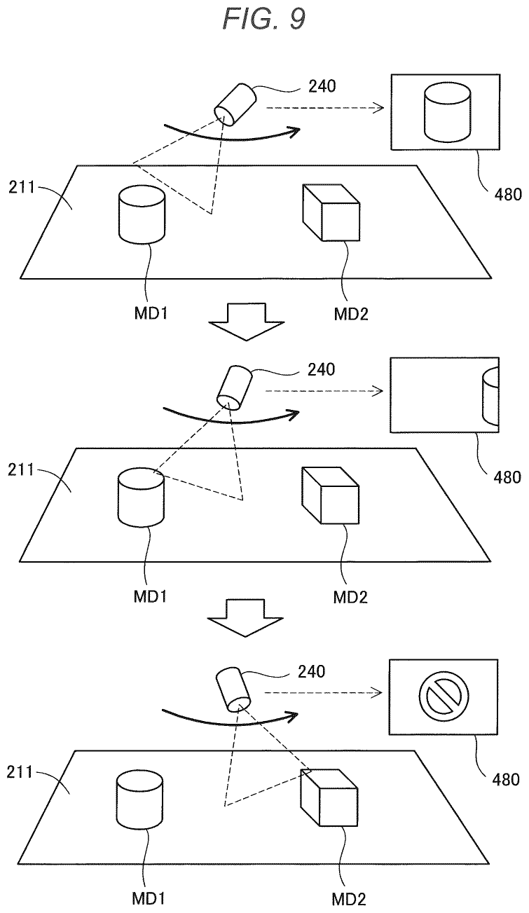

FIG. 8 is a flowchart of imaging processing of controlling the imaging unit 240 to image a model. FIG. 9 is a diagram of the imaging processing. The imaging processing is processing repeatedly executed by the control unit 300 during the operation of the three-dimensional molding apparatus 100, for example, during or after the execution of the molding processing explained above.

In step S10 in FIG. 8, the control unit 300 receives an operation instruction for the imaging unit 240 from the information processing apparatus 400. The operation instruction includes a user ID of a user operating apparatus 400 and imaging the information processing conditions. The imaging conditions include, for example, information indicating an imaging direction, a zoom ratio, an angle of view, and the like of the imaging unit 240. The user can designate any imaging range in the internal space of the three-dimensional molding apparatus 100 by designating an imaging direction, a zoom ratio, and an angle of view of the imaging unit 240 using the input device 470. The operation instruction includes the user ID. For that reason, the user is designated by the user ID.

An upper part of FIG. 9 illustrates a state in which a first model MD1 of the user himself/herself and a second model MD2 of another user are molded on the molding surface 211 and the first model MD1 is imaged by the imaging unit 240 and displayed on the display unit 480. By designating an imaging range, for example, the user can pan the imaging unit 240 as illustrated in a middle part of FIG. 9.

In step S20, the control unit 300 determines whether a model of another user is present within the imaging range designated by the user. The control unit 300 grasps a molding position on the molding surface 211 of each model of each user according to the attribute information received from the information processing apparatus 400. Therefore, the control unit 300 can determine, based on the attribute information received from the information processing apparatus 400 and the imaging range of the imaging unit 240, whether a model of another user is present in the imaging range.

When it is determined in step S20 that a model of another user is present in the imaging range, the control unit 300 determines in step S30 whether the imaging range can be restricted. Restricting the imaging range refers to, without changing the imaging direction, adjusting the angle of view or the zoom ratio of the imaging unit 240 such that the model of the other user is not imaged.

In step S30, when it is determined that the imaging range can be restricted, by adjusting the angle of view or the zoom ratio of the imaging unit 240, the control unit 300 restricts the imaging range such that the model of the other user is not imaged.

When it is determined in step S20 that a model of another user is absent in the imaging range or when the imaging range is restricted in step S40, the control unit 300 outputs a captured image in step S50. Specifically, the control unit 300 transmits image data of the model captured by the imaging unit 240 to the information processing apparatus 400 and causes the display unit 480 to display the image data.

In step S30, when it is determined that the imaging range cannot be restricted, that is, when the model of the other user is imaged even when the angle of view or the zoom ratio of the imaging unit 240 is adjusted, the control unit 300 skips the output of the captured image in step S50. Accordingly, the model of the other user is not displayed on the display unit 480. When the image data is not transmitted from the control unit 300, the CPU 410 of the information processing apparatus 400 may display, on the display unit 480, a predetermined mark indicating that the model cannot be displayed as illustrated in a lower part of FIG. 9. When it is determined in step S30 that the imaging range cannot be restricted, the control unit 300 may not skip the output of the captured image in step S50 but may stop the imaging operation by the imaging unit 240.

With the three-dimensional molding system 10 in the first embodiment explained above, the imaging unit 240 is disposed between the inner wall 101 and the outer wall 102 of the housing 105 and images, via the first transparent member 103, the model on the molding surface 211 housed in the internal space. For that reason, it is possible to prevent the imaging unit 240 from being affected by the heat in the internal space of the housing 105. As a result, the imaging unit 240 can stably image the model.

In the present embodiment, at least a part of the imaging unit 240 is disposed in a space at an upper corner in the space between the first frame 161 and the second frame 162 of the door 160 provided in the housing 105. For that reason, it is possible to disposed the imaging unit 240 in the housing 105 not be conspicuous.

In the present embodiment, a cover 108 that covers at least a part of the imaging unit 240 is provided between the imaging unit 240 and the second transparent member 104 on the inside of the door 160. For that reason, light made incident from the second transparent member 104 can be prevented from being reflected by the first transparent member 103 and reflected in the imaging unit 240. The cover 108 can be omitted.

In the present embodiment, the first end portion 164 of the door 160 has the opening and closing axis DX for opening and closing the door 160. The distance from the imaging unit 240 to the first end portion 164 is shorter than the distance from the imaging unit 240 to the second end portion 165 opposite to the first end portion 164. For that reason, wiring from the imaging unit 240 to the control unit 300 can be shortened. Since the imaging unit 240 and the second end portion 165 can be separated, it is possible to prevent an impact applied to the second end portion 165 from being transmitted to the imaging unit 240 when the door 160 is opened or closed.

In the present embodiment, by executing the imaging processing explained above, the control unit 300 adjusts the imaging range of the imaging unit 240 to image, of a first three-dimensional molded object corresponding to a first user and a second three-dimensional molded object corresponding to a second user molded at different positions on the molding surface 211, a molded object corresponding to a designated user and not to image a molded object corresponding to an undesignated user. Therefore, it is possible to prevent an image of a model of another user from being captured and displayed on the display unit 480.

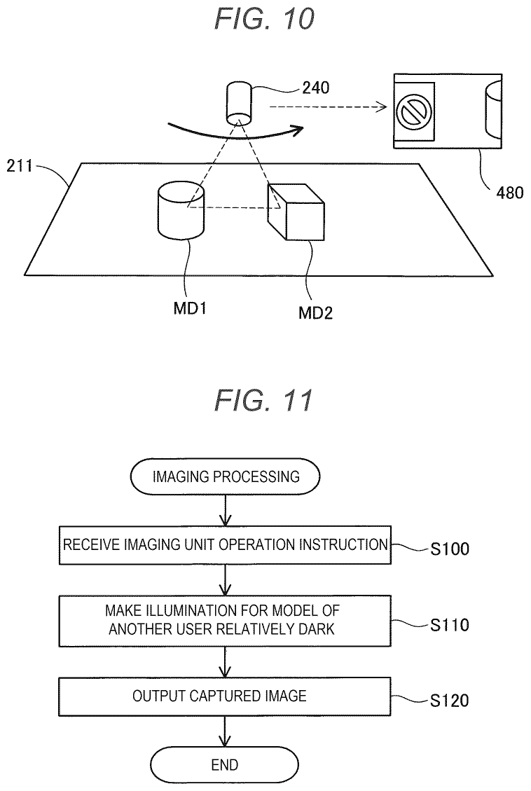

FIG. 10 is a diagram illustrating another processing example of the imaging processing according to the first embodiment. In the first embodiment explained above, in the imaging processing illustrated in FIG. 8, when a model of another user is present in the imaging range, the control unit 300 restricts the imaging range or stops the output of the captured image. In contrast, as illustrated in FIG. 10, when a model of another user is captured in the imaging range, the control unit 300 may apply, in real time, the image processing to a region where the model of the other user is captured.

As such image processing, mosaic processing may be applied to a region where the model of the other user is imaged or processing of superimposing a predetermined mark may be applied to the region. Such processing is referred to as obfuscation processing. That is, the control unit 300 may mold the first three-dimensional molded object corresponding to the first user and the second three-dimensional molded object corresponding to the second user at different positions on the molding surface 211, obfuscate an imaging range of the molded object corresponding to the undesignated user, and not obfuscate an imaging range of the molded object corresponding to the designated user. Accordingly, even when the model of the other user is displayed on the display unit 480, it is possible to make it difficult to visually recognize the model.

In the first embodiment explained above, the imaging unit 240 is disposed between the inner wall 101 and the outer wall 102 configuring the door 160. In contrast, the imaging unit 240 may be disposed in a part where the door 160 is absent in the housing 105. In this case, a portion of the inner wall 101 corresponding to the imaging direction of the imaging unit 240 is configured by the first transparent member 103.

In the first embodiment explained above, one imaging unit 240 is provided in the three-dimensional molding apparatus 100. The designated model is imaged by changing the imaging direction of the imaging unit 240. In contrast, the three-dimensional molding apparatus 100 may include a plurality of imaging units 240. In this case, rather than changing the imaging direction of the imaging unit 240, the imaging unit 240 closest to the designated model may be selected by the control unit 300 and the designated model may be imaged by the selected imaging unit 240.

### B. Second Embodiment

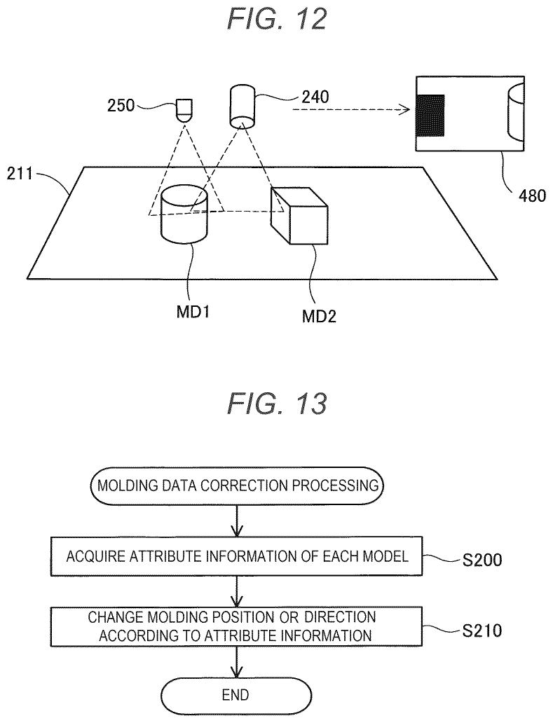

FIG. 11 is a flowchart of imaging processing in a second embodiment. FIG. 12 is a diagram of imaging processing in the second embodiment. The second embodiment is different from the first embodiment in content of the imaging processing. A configuration of the three-dimensional molding system 10 in the second embodiment is the same as that in the first embodiment.

In step S100 in FIG. 11, the control unit 300 receives an operation instruction for the imaging unit 240 from the information processing apparatus 400. As in the first embodiment, the operation instruction includes a user ID of a user operating the information processing apparatus 400 and imaging conditions.

In step S110, the control unit 300 makes illumination for a model of another user relatively dark. Specifically, the control unit 300 controls an irradiation direction of the light 250 to illuminate a model of a user who has given the operation instruction to the imaging unit 240 and not illuminate the model of the other user. FIG. 12 illustrates a state in which the model MD2 of the other user is displayed dark on the display unit 480 by not illuminating the model MD2 from the light 250.

In step S120, the control unit 300 outputs a captured image. Specifically, the control unit 300 transmits image data of the model captured by the imaging unit 240 to the information processing apparatus 400 and causes the display unit 480 to display the image data.

According to the second embodiment explained above, of the first model MD1 and the second model MD2 molded at different positions on the molding surface 211, the control unit 300 controls the light 250 to make the brightness of an undesignated molded object relatively darker than the brightness of a designated molded object. For that reason, it is possible to prevent an undesignated model from being clearly imaged and displayed on the display unit 480.

In the second embodiment, the light 250 may be attached to the imaging unit 240. Accordingly, an actuator for changing an imaging direction of the imaging unit 240 and an actuator for changing an illumination direction of the light 250 can be made common.

In the second embodiment, the model of the user who has given the operation instruction to the imaging unit 240 is illuminated and the model of the other user is not illuminated. In contrast, the control unit 300 may receive designation of a model to be illuminated irrespective of the user who has given the operation instruction to the imaging unit 240, illuminate the designated model, and not illuminate the undesignated model.

In the second embodiment, the three-dimensional molding apparatus 100 may include a plurality of lights 250 having different illumination directions. In this case, in step S110 explained above, the control unit 300 turns on the light 250, in an illumination range of which the model of the user who has given the operation instruction to the imaging unit 240 is in, and turns off the light 250, in an illumination range of which the model of the other user is in. This also makes it possible to clearly display the designated model on the display unit 480.

In the second embodiment, the three-dimensional molding system 10 may include a wide-area light that illuminates the entire internal space besides the light 250, the illumination direction of which is adjustable. In this case, when a model of another user is present on the molding surface 211, the control unit 300 may turn off the wide-area light in step S110 explained above. Accordingly, when a model of another user is present on the molding surface 211, the model of the other user can be darkened. When a model of another user is absent on the molding surface 211, the entire internal space can be illuminated. Therefore, the model of the user can be clearly imaged.

### C. Third Embodiment

FIG. 13 is a flowchart of molding data correction processing in a third embodiment. In the third embodiment, prior to molding processing of molding a model on the stage 210, the molding data correction processing illustrated in FIG. 13 is executed by the control unit 300. A configuration of the three-dimensional molding system 10 in the third embodiment is the same as that in the first embodiment. In the third embodiment, the imaging processing in the first and second embodiments may be executed or may not be executed.

As illustrated in FIG. 13, in the molding data correction processing, in step S200, the control unit 300 acquires attribute information of each model included in molding data from the information processing apparatus 400.

In step S210, the control unit 300 changes a molding position or direction of each model included in the molding data with respect to the imaging unit 240 according to the attribute information acquired in step S200.

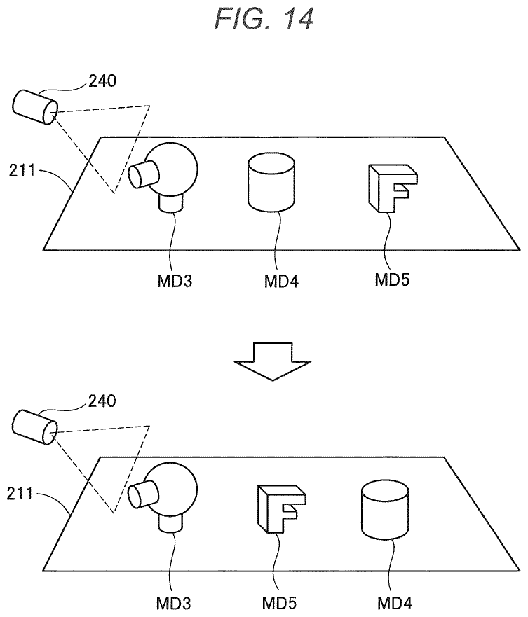

FIG. 14 is a diagram illustrating a first example of the molding data correction processing. In FIG. 14, in step S210, the control unit 300 changes the molding position of each model according to molding difficulty of each model. An upper part of FIG. 14 represents a molding position of each model before the change and a lower part of FIG. 14 represents a molding position after the change. In the example illustrated in FIG. 14, the molding difficulty of a third model MD3 is the highest, the molding difficulty of a fifth model MD5 is the second highest, and the molding difficulty of a fourth model MD4 is the lowest. The control unit 300 sets a molding position of a model having the highest molding as the closest position to the imaging unit 240 and sets a molding position of a model having the lowest molding difficulty as the most distant position from the imaging unit 240 as illustrated in the lower part of FIG. 14. That is, the control unit 300 disposes a model having higher molding difficulty closer to the imaging unit 240. In this way, it is possible to finely capture an image of a model having high molding difficulty with the imaging unit 240 and display the image on the display unit 480.

The CPU 410 of the information processing apparatus 400 sets the molding difficulty according to the number of facets. The number of facets refers to the number of meshes in the case in which the surface of a model is divided into triangular or quadrangular meshes. A model having a larger number of facets is more complicated and has higher molding difficulty. The number of facets includes the number of model facets and the number of support facets. The number of model facets is the number of facets of a substantial portion of the model and the number of support facets is the number of facets of a support portion that supports an overhang part of the model when the model is molded. The CPU 410 ranks the molding difficulty such as high, medium, and low according to the number of model facets. For models having the same number of model facets, the CPU 410 sets the molding difficulty of a model having a large number of support facets to molding difficulty of a rank higher than that of a model having a small number of support facets.

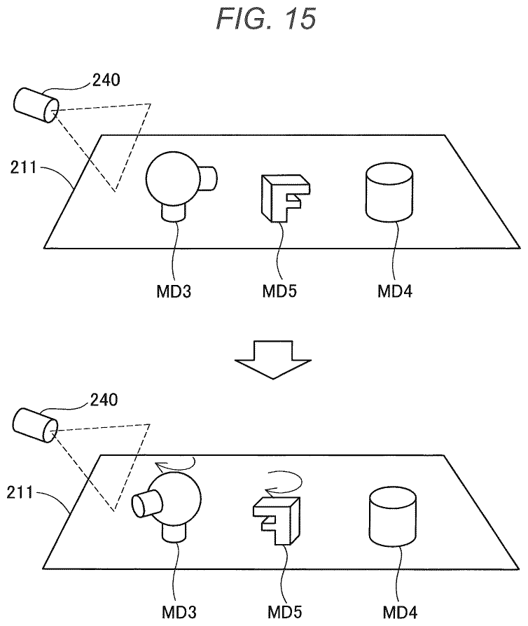

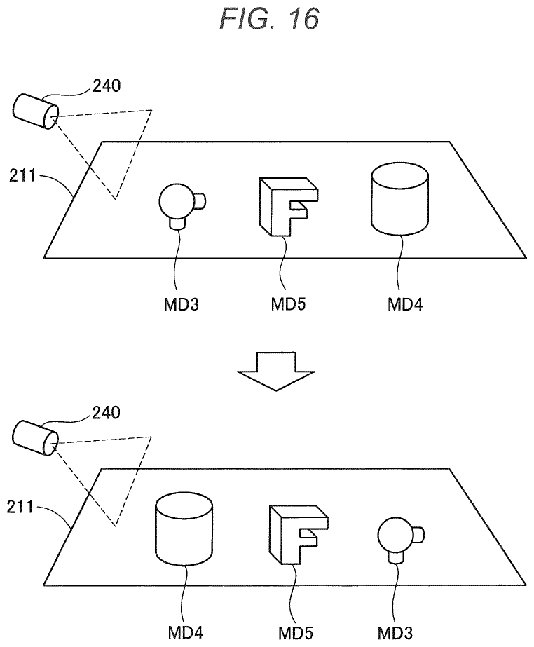

FIG. 15 is a diagram illustrating a second example of the molding data correction processing. The control unit 300 may change the direction of each model such that a surface having high molding difficulty among side surfaces of each model faces the imaging unit 240. An upper part of FIG. 15 illustrates a direction of each model before the change and a lower part of FIG. 15 illustrates a direction after the change. In FIG. 15, the directions of the third model MD3 and the fifth model MD5 are changed. The control unit 300 analyzes molding data and determines a surface having a high distribution rate of support or a surface having a large shape change of the surface of a support as a surface having a high molding difficulty. The CPU 410 of the information processing apparatus 400 may record information for identifying a surface having high molding difficulty in the attribute information in advance.

FIG. 16 is a diagram illustrating a third example of the molding data correction processing. In FIG. 16, in step S210 explained above, the control unit 300 changes a molding position of each model according to a confidentiality level of each model. An upper part of FIG. 16 represents a molding position of each model before the change and a lower part illustrates a molding position after the change. In the example illustrated in FIG. 16, a confidentiality level of the third model MD3 is the highest, a confidentiality level of the fifth model MD5 is the second highest, and a confidentiality level of the fourth model MD4 is the lowest. As illustrated in the lower part of FIG. 16, the control unit 300 disposes models side by side along an imaging direction of the imaging unit 240, sets a molding position of a model having the highest confidentiality level as the position most distant from the imaging unit 240, and sets a molding position of a model having the lowest confidentiality level as the closest position from the imaging unit 240. That is, the control unit 300 molds a model having a low confidentiality level between a model having a high confidentiality level and the imaging unit 240. Accordingly, the model having the high confidentiality level is disposed behind the model having the low confidentiality level. Therefore, it is possible to prevent an image of the model having the high confidentiality level from being captured in detail by the imaging unit 240 and displayed on the display unit 480.

In the third embodiment, as illustrated in FIGS. 14 to 16, an example is explained in which the control unit 300 changes the molding position or the direction of each model included in the molding data according to the molding difficulty or the confidentiality level. In contrast, instead of changing the generated molding data, the control unit 300 may determine the molding position and the direction of each model from the beginning based on the molding difficulty and the confidentiality level when the molding data is generated.

### D. Fourth Embodiment

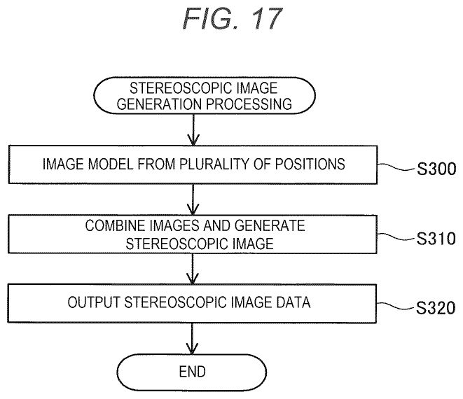

FIG. 17 is a flowchart of stereoscopic image generation processing according to a fourth embodiment. The stereoscopic image generation processing is processing executed by the control unit 300 when a predetermined instruction is given from a user during or after the execution of the molding processing explained above. In the fourth embodiment, the imaging processing in the first and second embodiments and the molding data correction processing in the third embodiment may be executed or may not be executed.

In the stereoscopic image generation processing, in step S300, the control unit 300 images a model on the molding surface 211 from a plurality of positions using the imaging unit 240.

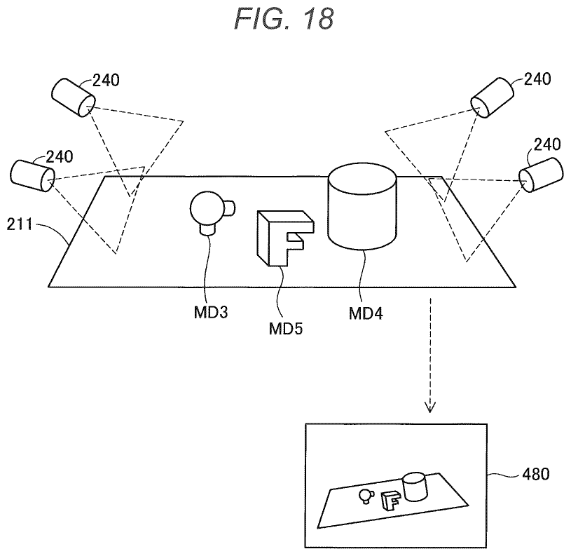

FIG. 18 is a diagram of the stereoscopic image generation processing. In the fourth embodiment, the three-dimensional molding apparatus 100 includes a plurality of imaging units 240 having different attachment positions. In step S310 explained above, the control unit 300 controls each of the imaging units 240 to image a model from a plurality of positions.

In step S310, the control unit 300 generates a stereoscopic image based on imaging results of the model imaged from the plurality of positions. As an algorithm for generating a stereoscopic image, a well-known algorithm can be used, for example, a view volume intersection method can be used.

In step S320 in FIG. 17, the control unit 300 outputs stereoscopic image data representing a generated stereoscopic image to the information processing apparatus 400. The information processing apparatus 400 displays a stereoscopic image of the model on the display unit 480 using the received stereoscopic image data. FIG. 18 illustrates an example in which a stereoscopic image generated by the control unit 300 is displayed on the display unit 480. The user can observe the shape and the disposition of the model from any viewpoint by operating the input device 470 of the information processing apparatus 400. The stereoscopic image displayed on the display unit 480 can also be referred to as digital twin image.

According to the fourth embodiment explained above, it is possible to cause the display unit 480 to display a stereoscopic image by imaging, with the imaging unit 240, a molded model or a model being molded from a plurality of positions. For that reason, even when the internal space of the three-dimensional molding apparatus 100 cannot be directly visually recognized, the disposition and the shape of the model can be checked from any viewpoint.

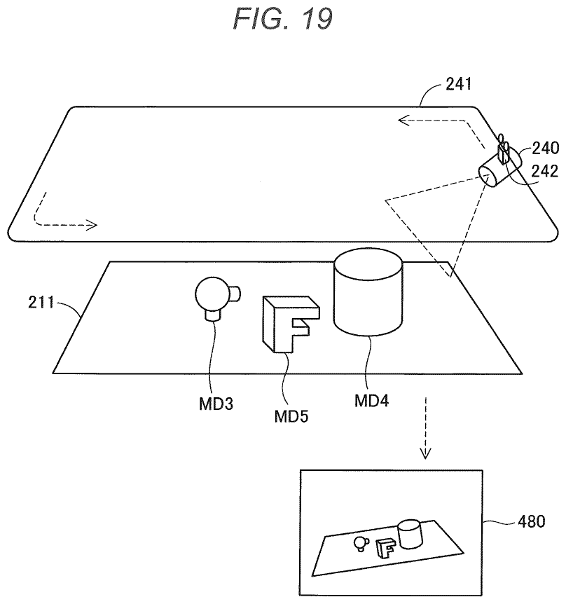

FIG. 19 is a diagram illustrating a first modification of the fourth embodiment. In the fourth embodiment explained above, the plurality of imaging units 240 are provided in the three-dimensional molding apparatus 100. In contrast, the imaging unit 240 may be configured to be movable around the molding surface 211 between the inner wall 101 and the outer wall 102 configuring the housing 105 of the three-dimensional molding apparatus 100. Specifically, as illustrated in FIG. 19, a rail 241 is disposed between the inner wall 101 and the outer wall 102 not illustrated in the figure and the imaging unit 240 is suspended from the rail 241 by a support unit 242. Then, the control unit 300 drives a motor provided in the support unit 242 according to a designated imaging position, rotates a rotating body that is in contact with the rail 241, and moves the imaging unit 240. In order to make it possible to image an internal section with the imaging unit 240, the first transparent member 103 is disposed in a portion of the inner wall 101 of the housing 105 corresponding to the moving range of the imaging unit 240. With such a configuration, the control unit 300 can image the model from any position. Therefore, a stereoscopic image can be accurately generated.

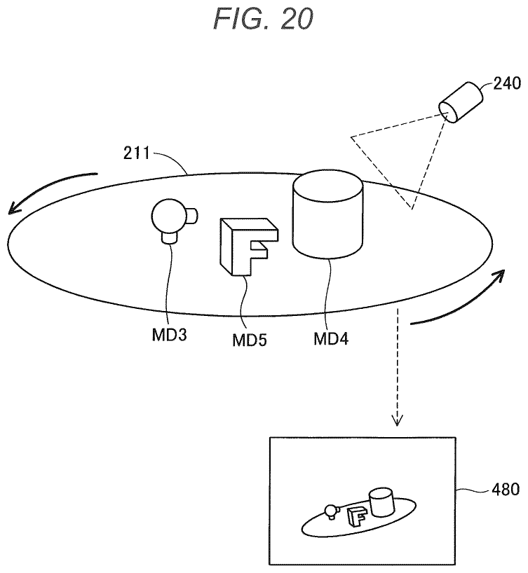

FIG. 20 is a diagram illustrating a second modification of the fourth embodiment. In the first modification explained above, the imaging unit 240 moves around the molding surface 211. In contrast, in the second modification illustrated in FIG. 20, the position of the imaging unit 240 is fixed and the molding surface 211 rotates. In this case, the position changing unit 230 includes a motor for rotating the molding surface 211. Even with such a configuration, as in the first modification, the control unit 300 can image the model from any position. Therefore, a stereoscopic image can be accurately generated. The configurations of the first modification and the second modification explained above can be applied not only to the fourth embodiment but also to the first to third embodiments.

### E. Other Embodiments

(E1) In the embodiments explained above, the molding unit 110 plasticizes the material with the flat screw 40. In contrast, the molding unit 110 may plasticize the material by, for example, rotating an in-line screw. The molding unit 110 may plasticize a filament-like material with a heater.

(E2) In the embodiments explained above, the processing executed by the control unit 300 of the three-dimensional molding apparatus 100 may be executed by the CPU 410 of the information processing apparatus 400. The processing executed by the CPU 410 of the information processing apparatus 400 may be executed by the control unit 300 of the three-dimensional molding apparatus 100. Both of the control unit 300 of the three-dimensional molding apparatus 100 and the CPU 410 of the information processing apparatus 400 correspond to the control unit in the present specification.

(E3) In the above embodiment, the door 160 is the door that opens and closes centering on the opening and closing axis DX. In contrast, the door 160 may be a sliding door that slides along a rail.

### F. Other Aspects

The present disclosure is not limited to the embodiments explained above and can be implemented in various configurations without departing from the gist of the present disclosure. For example, technical features of the embodiments corresponding to technical features in aspects described below can be substituted or combined as appropriate in order to solve a part or all of the problems explained or in order to achieve a part or all of the effects explained above. Unless the technical features are explained as essential technical features in the present specification, the technical features can be deleted as appropriate.

(1) According to a first aspect of the present disclosure, a three-dimensional molding system is provided. The three-dimensional molding system includes: a molding unit including a heater for plasticizing a material to generate a molding material and a nozzle for discharging the molding material; a stage including a molding surface on which the molding material is stacked; a position changing unit configured to change relative positions of the stage and the nozzle; an imaging unit disposed further on an outer side than an outer edge of the molding surface when viewed from a direction perpendicular to the molding surface; a housing including an inner wall that defines an internal space and an outer wall that comes into contact with outside air and configured to house the molding surface in the internal space; and a control unit configured to control the molding unit and the position changing unit based on molding data to mold a three-dimensional molded object on the molding surface in the housing, wherein at least a part of the inner wall is made of a first transparent member, and the imaging unit is disposed between the inner wall and the outer wall and images, via the first transparent member, the three-dimensional molded object on the molding surface housed in the internal space.

According to such an aspect, the imaging unit is disposed between the inner wall and the outer wall of the housing and images, via the first transparent member, the three-dimensional molded object on the molding surface housed in the internal space. For that reason, it is possible to prevent the imaging unit from being affected by heat in the internal space of the housing. As a result, the imaging unit can stably image the three-dimensional molded object.

(2) In the aspect explained above, the housing may include a door having a part of the inner wall and a part of the outer wall, the part of the inner wall configuring the door may be configured by the first transparent member, the part of the outer wall configuring the door may be configured by a second transparent member facing the first transparent member, the door may include a first frame surrounding the first transparent member and a second frame surrounding the second transparent member, and at least a part of the imaging unit may be disposed in a space at an upper corner in a space between the first frame and the second frame. According to such an aspect, the imaging unit can be disposed in the housing not to be conspicuous.

(3) In the aspect explained above, a cover at least partially facing the second transparent member and covering at least a part of the imaging unit may be provided between at least a part of the imaging unit and the second transparent member. According to such an aspect, it is possible to prevent light made incident from the second transparent member from being reflected by the first transparent member and being reflected in the imaging unit.

(4) In the aspect explained above, the door may include a first end portion and a second end portion opposite to the first end portion, the first end portion may have an opening and closing axis for opening and closing the door, and a distance from the imaging unit to the first end portion may be shorter than a distance from the imaging unit to the second end portion. According to such an aspect, wiring from the imaging unit to the control unit can be shortened. Since the imaging unit and the second end portion can be separated, it is possible to prevent an impact applied to the second end portion according to the opening and closing of the door from being transmitted to the imaging unit.

(5) In the aspect explained above, the imaging unit may be configured to be capable of adjusting an imaging range, the control unit may mold a first three-dimensional molded object corresponding to a first user and a second three-dimensional molded object corresponding to a second user at different positions on the molding surface, and the control unit may adjust the imaging range to image, of the first three-dimensional molded object and the second three-dimensional molded object, a molded object corresponding to a designated user and not to image a molded object corresponding to an undesignated user. According to such an aspect, it is possible to prevent a model of undesignated another user from being imaged.

(6) In the aspect explained above, the control unit may mold a first three-dimensional molded object corresponding to a first user and a second three-dimensional molded object corresponding to a second user at different positions on the molding surface, and the control unit may obfuscate an imaging range of a molded object corresponding to an undesignated user and not obfuscate an imaging range of a molded object corresponding to a designated user. According to such an aspect, it is possible to make it difficult to visually recognize a model of undesignated another user.

(7) In the aspect explained, the three-dimensional molding system further includes a light that illuminates the internal space, the light may be configured to be capable of adjusting an illumination range, the control unit may shape a first three-dimensional molded object and a second three-dimensional molded object at different positions on the molding surface, and the control unit may control the light to make brightness of an undesignated molded object relatively lower than brightness of a designated molded object of the first three-dimensional molded object and the second three-dimensional molded object. According to such an aspect, it is possible to prevent an undesignated model from being clearly imaged.

(8) In the aspect explained above, the control unit may mold, at different positions on the molding surface, a first three-dimensional molded object and a second three-dimensional molded object that are different in at least one of molding difficulty and a degree of confidentiality.

(9) In the aspect explained above, the control unit may determine at least one of positions and directions of the first three-dimensional molded object and the second three-dimensional molded object with respect to the imaging unit according to at least one of the molding difficulty and the degree of confidentiality.

(10) In the aspect explained above, the control unit may determine the positions of the first three-dimensional molded object and the second three-dimensional molded object with respect to the imaging unit such that, of the first three-dimensional molded object and the second three-dimensional molded object, a molded object, the molding difficulty of which is high, is located closer to the imaging unit than a molded object, the molding difficulty of which is low. With such a configuration, it is possible to finely image a molded object having molding difficulty.

(11) In the aspect explained above, the control unit may determine the positions of the first three-dimensional molded object and the second three-dimensional molded object with respect to the imaging unit such that, of the first three-dimensional molded object and the second three-dimensional molded object, a molded object, the confidentiality of which is low, is located between a molded object, the confidentiality of which is high, and the imaging unit. With such a configuration, it is possible to prevent a three-dimensional molded object having high confidentiality from being imaged in detail by the imaging unit.

(12) In the aspect explained above, the imaging unit may be configured to be capable of imaging the three-dimensional molded object from a plurality of different positions, and the control unit may generate a stereoscopic image of the three-dimensional molded object based on an imaging result by the imaging unit. According to such an aspect, by displaying a stereoscopic image, even when an internal space of a three-dimensional molding apparatus cannot be directly visually recognized, the disposition and the shape of a three-dimensional molded object can be checked from any viewpoint.

(13) In the aspect explained above, the imaging unit may be configured to be movable around the molding surface between the inner wall and the outer wall, and a portion of the inner wall corresponding to a movement range of the imaging unit may be configured by the first transparent member. According to such an aspect, the three-dimensional molded object can be imaged from any direction.

The present disclosure is not limited to the three-dimensional molding system explained above and can be implemented by various aspects such as a three-dimensional molding apparatus, an information processing apparatus, a computer program, and a non-transitory tangible recording medium recording a computer program to be readable by a computer.

What is claimed is:

1. A three-dimensional molding system, comprising:
a molding unit including a heater for plasticizing a material to generate a molding material and a nozzle for discharging the molding material;
a stage including a molding surface on which the molding material is stacked;
a position changing unit configured to change relative positions of the stage and the nozzle;
an imaging unit disposed further on an outer side than an outer edge of the molding surface when viewed from a direction perpendicular to the molding surface;
a housing including an inner wall that defines an internal space and an outer wall that comes into contact with outside air and configured to house the molding surface in the internal space; and
a control unit configured to control the molding unit and the position changing unit based on molding data to mold a three-dimensional molded object on the molding surface in the housing, wherein
at least a part of the inner wall is made of a first transparent member, and
the imaging unit is disposed between the inner wall and the outer wall and images, via the first transparent member, the three-dimensional molded object on the molding surface housed in the internal space.

2. The three-dimensional molding system according to claim 1, wherein
the housing includes a door having a part of the inner wall and a part of the outer wall,
the part of the inner wall configuring the door is configured by the first transparent member,
the part of the outer wall configuring the door is configured by a second transparent member facing the first transparent member,
the door includes a first frame surrounding the first transparent member and a second frame surrounding the second transparent member, and
at least a part of the imaging unit is disposed in a space at an upper corner in a space between the first frame and the second frame.

3. The three-dimensional molding system according to claim 2, wherein a cover at least partially facing the second transparent member and covering at least a part of the imaging unit is provided between at least a part of the imaging unit and the second transparent member.

4. The three-dimensional molding system according to claim 2, wherein
the door includes a first end portion and a second end portion opposite to the first end portion,
the first end portion has an opening and closing axis for opening and closing the door, and
a distance from the imaging unit to the first end portion is shorter than a distance from the imaging unit to the second end portion.

5. The three-dimensional molding system according to claim 1, wherein the imaging unit is configured to be capable of adjusting an imaging range,
the control unit molds a first three-dimensional molded object corresponding to a first user and a second three-dimensional molded object corresponding to a second user at different positions on the molding surface, and
the control unit adjusts the imaging range to image, of the first three-dimensional molded object and the second three-dimensional molded object, a molded object corresponding to a designated user and not to image a molded object corresponding to an undesignated user.

6. The three-dimensional molding system according to claim 1, wherein
the control unit molds a first three-dimensional molded object corresponding to a first user and a second three-dimensional molded object corresponding to a second user at different positions on the molding surface, and
the control unit obfuscates an imaging range of a molded object corresponding to an undesignated user and does not obfuscate an imaging range of a molded object corresponding to a designated user.

7. The three-dimensional molding system according to claim 1, further comprising a light that illuminates the internal space, wherein
the light is configured to be capable of adjusting an illumination range,
the control unit molds a first three-dimensional molded object and a second three-dimensional molded object at different positions on the molding surface, and
the control unit controls the light to make brightness of an undesignated molded object relatively lower than brightness of a designated molded object of the first three-dimensional molded object and the second three-dimensional molded object.

8. The three-dimensional molding system according to claim 1, wherein the control unit molds, at different positions on the molding surface, a first three-dimensional molded object and a second three-dimensional molded object that are different in at least one of molding difficulty and a degree of confidentiality.

9. The three-dimensional molding system according to claim 8, wherein the control unit determines at least one of positions and directions of the first three-dimensional molded object and the second three-dimensional molded object with respect to the imaging unit according to at least one of the molding difficulty and the degree of confidentiality.

10. The three-dimensional molding system according to claim 9, wherein the control unit determines the positions of the first three-dimensional molded object and the second three-dimensional molded object with respect to the imaging unit such that, of the first three-dimensional molded object and the second three-dimensional molded object, a molded object, the molding difficulty of which is high, is located closer to the imaging unit than a molded object, the molding difficulty of which is low.

11. The three-dimensional molding system according to claim 9, wherein the control unit determines the positions of the first three-dimensional molded object and the second three-dimensional molded object with respect to the imaging unit such that, of the first three-dimensional molded object and the second three-dimensional molded object, a molded object, the confidentiality of which is low, is located between a molded object, the confidentiality of which is high, and the imaging unit.

12. The three-dimensional molding system according to claim 1, wherein
the imaging unit is configured to be capable of imaging the three-dimensional molded object from a plurality of different positions, and
the control unit generates a stereoscopic image of the three-dimensional molded object based on an imaging result by the imaging unit.

13. The three-dimensional molding system according to claim 1, wherein
the imaging unit is configured to be movable around the molding surface between the inner wall and the outer wall, and
a portion of the inner wall corresponding to a movement range of the imaging unit is configured by the first transparent member.
